(19) United States
(12) Patent Application Publication
(10) Pub. No.: US 2013/0127149 A1
(43) Pub. Date: May 23, 2013

(54) DEINKABLE PRINT

(71) Applicants: Thomas Nathaniel Tombs, Rochester, NY (US); Donald Saul Rimai, Webster, NY (US)

(72) Inventors: Thomas Nathaniel Tombs, Rochester, NY (US); Donald Saul Rimai, Webster, NY (US)

(21) Appl. No.: 13/298,361

(22) Filed: Nov. 17, 2011

(51) Int. Cl. B42D 15/00

(52) U.S. Cl. 283/62

(57) ABSTRACT

A printed article includes a receiver having an image-bearing surface, the image-bearing surface having substantially no human-visible colorant thereon. A pattern of toner is deposited on the image-bearing surface and covers less than 100% of the image-bearing surface. Colorant is absorbed into or adsorbed onto the toner to provide a human-visible image.

### CROSS-REFERENCE TO RELATED APPLICATIONS

Reference is made to commonly assigned, U.S. patent application Ser. No. ______ (Attorney Docket Number K000276), filed concurrently herewith, entitled “PRODUCING A DEINKABLE PRINT,” by Tombs et al.; U.S. patent application Ser. No. ______ (Attorney Docket Number K000280), filed concurrently herewith, entitled “PRODUCING A DEINKABLE PRINT,” by Tombs et al.; and U.S. patent application Ser. No. ______ (Attorney Docket Number K000679), filed concurrently herewith, entitled “DEINKING A PRINT,” by Tombs et al.; the disclosures of which are incorporated by reference herein.

### FIELD OF THE INVENTION

This invention pertains to the field of printing and more particularly to deinkable printed matter.

### BACKGROUND OF THE INVENTION

Printers are useful for producing printed images of a wide range of types. Printers print on receivers (or “imaging substrates”), such as pieces or sheets of paper or other planar media, glass, fabric, metal, or other objects. Printers typically operate using subtractive color: a substantially reflective receiver is overcoated image-wise with cyan (C), magenta (M), yellow (Y), black (K), and other colorants.

In order to recycle receivers that have been printed on, it is desirable to remove the colorant on the receiver. Removal processes are referred to as “deinking” processes. Deinking the receivers permits them to be recycled without having to bleach the color out of them. However, commonly-used inkjet printers deposit hydrophilic ink on absorbent papers. As the ink soaks into the paper after printing, the dyes or pigments in the inks become adhered to or embedded in the paper. These colorants are very difficult to remove.

There is a need, therefore, for a way of providing inkjet prints that can be deinked and recycled.

### SUMMARY OF THE INVENTION

According to an aspect of the present invention, there is provided a printed article, comprising:
a) a receiver having an image-bearing surface, the image-bearing surface having substantially no human-visible colorant thereon;
b) a pattern of toner deposited on the image-bearing surface and covering less than 100% of the image-bearing surface; and
c) colorant absorbed into or adsorbed onto the toner to provide a human-visible image.

An advantage of this invention is that it provides a readily-deinkable and -recyclable print using readily-available hydrophilic inks. The print can be deinked using conventional deinking solvents. In various embodiments, deinkable materials are deposited only in the inked areas, and not in the noninked areas. This saves material compared to flood-coating a receiver with an ink-absorbent material. It also permits a viewer of the print to perceive the physical, textural, and visible attributes of the paper, which attributes a flood-coat would mask. Various embodiments do not use a continuous coating on paper. Continuous coatings can crack or delaminate when the paper swells and shrinks as its moisture content changes; embodiments not using a continuous coating do not suffer from cracking or delamination and attendant image-quality losses.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of a reproduction apparatus;

FIGS. 2A-2B show a graphical representation of an interaction between ink and toner according to various embodiments; and

FIG. 3 shows methods of printing an image according to various embodiments.

The attached drawings are for purposes of illustration and are not necessarily to scale.

### DETAILED DESCRIPTION OF THE INVENTION

Toner printing processes, such as electrophotographic (EP), electrostatographic, ionographic, and electrographic, and inkjet printing processes can be embodied in devices including printers, copiers, scanners, and facsimiles, and analog or digital devices, all of which are referred to herein as “printers.”

Printers operate by depositing marking material (e.g., toner or ink) on a receiver (e.g., paper). In a multi-color printer, each color is referred to as a “component,” and there is a different marking material for each color component. A printer typically includes a digital front-end processor (DFE), a marking engine (also referred to in the art as a “print engine”) for applying marking material to the receiver, and one or more post-printing finishing system(s) (e.g. a UV coating system, a glosser, or a laminator). The DFE rasterizes input electronic files into image bitmaps for the marking engine to print, and permits operator control of the output. The marking engine takes the rasterized image bitmap from the DFE and renders the bitmap into a form that can control the printing process. The finishing system applies features such as protection, glossing, or binding to the prints. The printer can also include a color management system that captures the characteristics of the image printing process implemented in the marking engine (e.g. the electrophotographic process) to provide known, consistent color reproduction characteristics for various types of input (e.g. digital camera images or film images).

Multi-component (e.g., color) print images are typically made in a plurality of color imaging modules arranged in tandem, and the print images for each color component are successively transferred to a receiver moving through the modules. The receiver can be a web, or can be cut sheets held on a transport belt. Images for each color component can also be transferred to an intermediate, then transferred together to the receiver.

Some printers can deposit clear marking material (e.g., clear toner or transparent ink). As used herein, “clear” is considered to be a color of toner, as are cyan (C), magenta (M), yellow (Y), black (K), and light black (Lk), but the term “colored marking material” excludes clear marking material. Clear marking material can protect a print from fingerprints and reduce certain visual artifacts. Clear marking material can be similar to colored marking material, but without a colorant (e.g. dye or pigment) incorporated into the toner particles. Printers can also print tinted marking materials. These absorb less light than they transmit, but do contain colorants (e.g., pigments or dyes) that move the hue of light passing through them towards the hue of the tint.

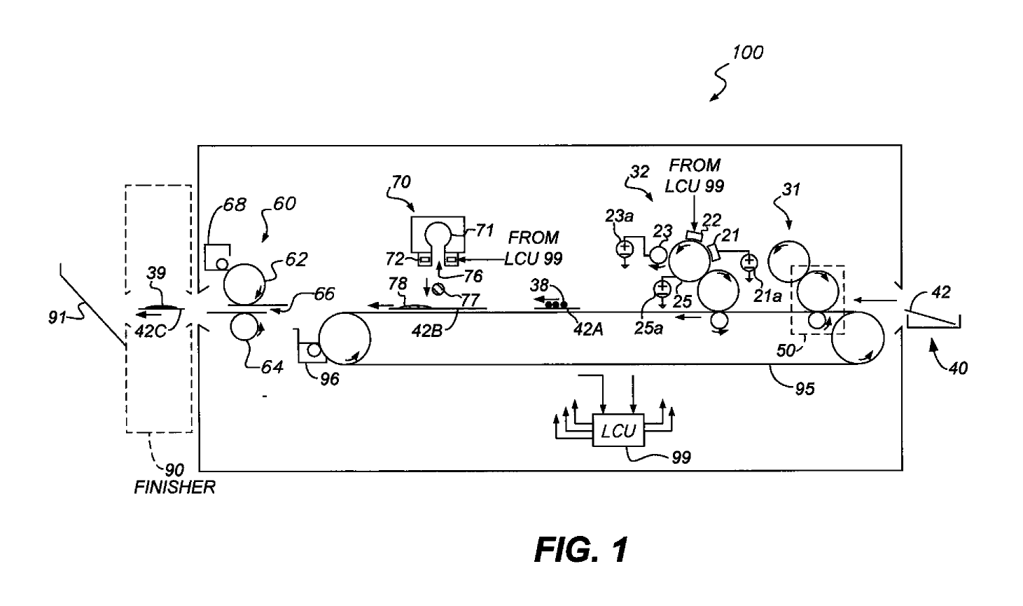

FIG. 1 is an elevational cross-section showing portions of a printer. Printer 100 produces print images having one or more color components, e.g., four or six components. Various components of printer 100 are shown as rollers; other configurations are also possible, including belts.

Printer 100 has one or more tandemly-arranged marking engines 31, 32, 70. Each marking engine 31, 32, 70 produces a print image for a single color component.

Marking engines 31 and 32 are EP marking engines. Each transfers its print image to receiver 42 using respective transfer subsystem 50 (for clarity, only one is labeled). Receiver 42 is transported from supply unit 40, which can include active feeding subsystems as known in the art, into printer 100. In various embodiments, the visible image can be transferred directly from an imaging roller to a receiver 42, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each marking engine 31, 32, 70 includes various components. For clarity, these are only shown in EP marking engine 32. Around photoreceptor 25 are arranged, ordered by the direction of rotation of photoreceptor 25, charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster opₜical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image may not be visible to the naked eye depending on the composition of the toner particles (e.g. clear toner). Toning station 23 can also be referred to as a development station. Toner can be applied to either the charged or discharged parts of the latent image.

After the latent image is developed into a visible image on photoreceptor 25, a suitable receiver 42 is brought into juxtaposition with the visible image. In transfer subsystem 50, a suitable electric field is applied to transfer the toner particles of the visible image to receiver 42 to form the desired toner image 38, which includes unfused toner particles, on the receiver, as shown on receiver 42A. The imaging process is typically repeated many times with reusable photoreceptors 25.

Various parameters of the components of an EP marking engine (e.g., marking engines 31, 32) can be adjusted to control the operation of printer 100. In an embodiment, charger 21 is a corona charger including a grid between the corona wires (not shown) and photoreceptor 25. Voltage source 21 a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by logic and control unit (LCU) 99 to produce a latent image corresponding to the desired print image. All of these parameters can be changed.

Further details regarding EP marking engines 31, 32 and related components are provided in U.S. Pat. No. 6,608,641, issued on Aug. 19, 2003, to Peter S. Alexandrovich et al., in U.S. Publication No. 2006/0133870, published on Jun. 22, 2006, by Yee S. Ng et al., and U.S. patent application Ser. No. 12/942,420, filed Nov. 9, 2010, by Thomas N. Tombs et al., all of which are incorporated herein by reference.

Marking engine 70 is an inkjet marking engine. Inkjet marking engine 70 can include a drop-on-demand printhead, either thermal or piezoelectric, or a continuous printhead, using gas, electrostatic, or other deflection methods. The example shown in FIG. 1 is a thermal drop-on-demand marking engine.

Inkjet marking engine includes ink manifold 71 that contains liquid ink, either under pressure or not. Heater 72 is a resistive ring heater around nozzle 76 that heats ink in ink manifold 71 to its boiling point. The expansion in volume as the liquid boils into gas drives ink drop 77 out of nozzle 76 towards receiver 42B. A previously-jetted ink drop is shown; it has spread out on receiver 42B to form ink image 78, as discussed below. Further details of inkjet marking engines are found in U.S. patent application Ser. No. 13/245,931, U.S. Pat. Nos. 6,588,888, 4,636,808, and 6,851,796, all of which are incorporated herein by reference.

Piezoelectric drop-on-demand systems provide current to a piezoelectric actuator to cause it to deflect and push an ink drop out of ink manifold 71. Continuous-inkjet systems pressurize the ink in ink manifold 71 and break it into drops in a controlled manner, e.g., by selectively heating the ink stream in an appropriate timing sequence. In gas-deflection systems, two sizes of drops are produced, and an air flow not parallel with the direction of drop travel separates the two sizes of drops. Drops of one size strike the receiver; drops of the other size are caught and reused. Electrostatic-deflection systems charge drops to one of two charge states, and Lorentz forces between the drops and an electrode separate the two sizes of drops.

After toner image 38, ink image 78, or both are deposited on receiver 42, receiver 42B is subjected to heat or pressure to permanently fix (“fuse”) toner image 38 to receiver 42A. Plural print images, e.g. of separations of different colors, are overlaid on one receiver before fusing to form a multi-color fused image 39 on receiver 42C.

Fuser 60, i.e., a fusing or fixing assembly, fuses toner image 38 to receiver 42A. Transport web 95 transports the toner-image-carrying receivers (e.g., 42A, 42B) to fuser 60, which fixes the toner particles to the respective receivers 42C by the application of heat and pressure. The receivers 42A are serially de-tacked from transport web 95 to permit them to feed cleanly into fuser 60. Transport web 95 is then reconditioned for reuse at cleaning station 96 by cleaning and neutralizing the charges on the opposed surfaces of the transport web 95.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed. A drying station (not shown) can also be used to remove carrier fluid (discussed below) from receiver 42A before receiver 42A reaches fuser 60.

The receivers (e.g., receiver 42C) carrying the fused image (e.g., fused image 39) are transported from the fuser 60 along a path either to output tray 91, or back to marking engines 31, 32, 70 to create an image on the backside of the receiver (e.g., receiver 42C), i.e. to form a duplex print.

In various embodiments, between fuser 60 and output tray 91, receiver 42B passes through finisher 90. Finisher 90 performs various media-handling operations, such as folding, stapling, saddle-stitching, collating, and binding.

Printer 100 includes logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data

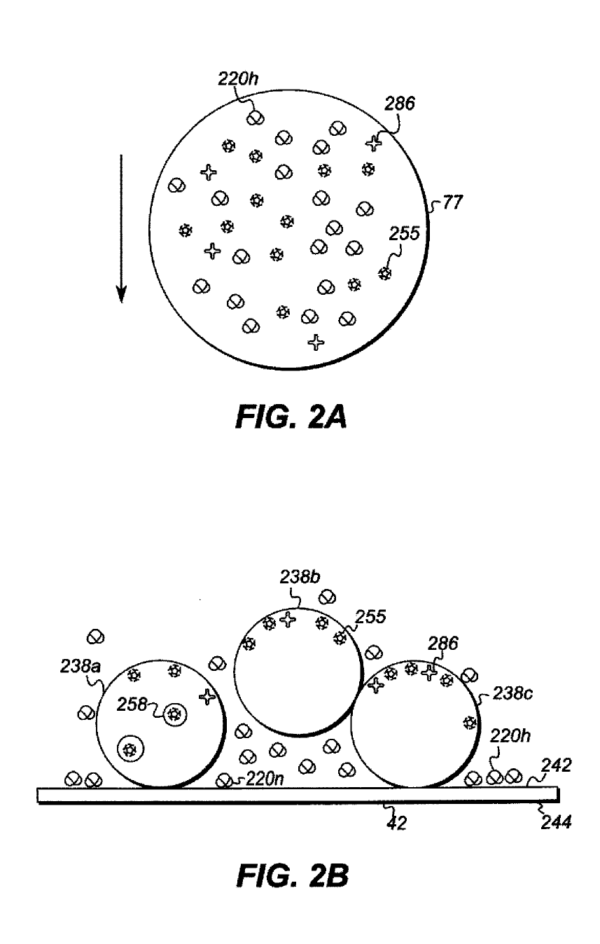

FIGS. 2A-2B show a graphical representation of an interaction between ink and toner according to various embodiments. Referring to FIG. 2A, ink drop 77 travelling towards receiver 42 (FIG. 2B) includes carrier fluid molecules 220h (e.g., water molecules), represented graphically as space-filling models of H₂O molecules. Ink drop 77 can include colorant 255. Colorant 255 can include, e.g., dye or pigment particles or molecules. Examples of colorants are given in U.S. Pat. No. 5,972,089, the disclosure of which is incorporated herein by reference, and include copper phthalocyanine (pigment blue 15), quinacridone magenta (pigment red 122), pigment yellow 138, or carbon black (pigment black 7).

Ink drop 77 can also include materials that are transported in the ink but that do not serve as visual markers. These materials are referred to herein as “functional components.” Functional components 286 can include security markers. Security markers can include materials that are not visible to the unaided human eye but that can be detected using specific instrumentation. Security markers can also include materials that are visible to the unaided human eye only under atypical illumination conditions, e.g., UV-fluorescent colorants (e.g., as described in U.S. Pat. No. 6,541,100, incorporated herein by reference). Functional components can also include fungicides or biocides (e.g., bacteriocides; examples are given in U.S. Pat. No. 7,976,147, incorporated herein by reference) that resist the growth of spores in a printed article to which they are applied. Functional components 286 can also include humectants to reduce the probability that ink will dry and thicken or solidify in nozzle 76 (e.g., in U.S. Pat. No. 5,725,647, incorporated herein by reference), or surfactants to disperse colorant in the carrier fluid (e.g., in U.S. Pat. No. 6,059,869, incorporated herein by reference). Functional components 286 can be particles, molecules, or atoms, and can be suspended or dissolved in ink drop 77.

FIG. 2B shows the situation after ink drop 77 has come into contact with receiver 42 bearing toner particles 238a, 238b, 238c. As shown, most of the carrier fluid molecules (e.g., molecule 220h) have passed around, or through gaps between, toner particles 238a, 238b, 238c. In various embodiments, some carrier fluid molecules are absorbed into receiver 42. In other embodiments, recever 42 does not absorb carrier fluid (e.g., carrier fluid molecule 220n has not been absorbed). Colorant 255 is absorbed into, or adsorbed onto, toner particles 238a, 238b, 238c, or pores 258 therein. As a result, colorant 255 forms an image in toner particles 238a, 238b, 238c rather than soaking into receiver 42. Optional functional components 286 are also absorbed into, or adsorbed onto, toner particles 238a, 238b, 238c, or pores 258 therein. In some embodiments, only colorant 255 is used, and not functional components 286; in other embodiments, only functional components 286 are used, and not colorant 255, and in yet other embodiments, colorant 255 and functional components 286 are both used.

A result of this printing process is a printed article on receiver 42 having image-bearing surface 242. In various embodiments, the image-bearing surface 242 has substantially no human-visible colorant thereon. For example, there is substantially no human-visible colorant if image-bearing surface 242, when toner particles 238a, 238b, 238c are removed therefrom, has a reflectance uniformity of within ±5ΔE* (CIELAB 1976) over its entire surface. There is also substantially no human-visible colorant if, when toner particles 238a, 238b, 238c are removed from image-bearing surface 242, the density of image-bearing surface 242 is at most 0.03 across image-bearing surface 242. Colorant 255 on image-bearing surface 242 or buried shallowly enough in receiver 42 that it still affects the reflection density of image-bearing surface 242 can be human-visible. The pattern of toner 238a, 238b, 238c deposited on image-bearing surface 242 covers less than 100% of image-bearing surface 242. Colorant 255 is absorbed into the toner to provide a human-visible image.

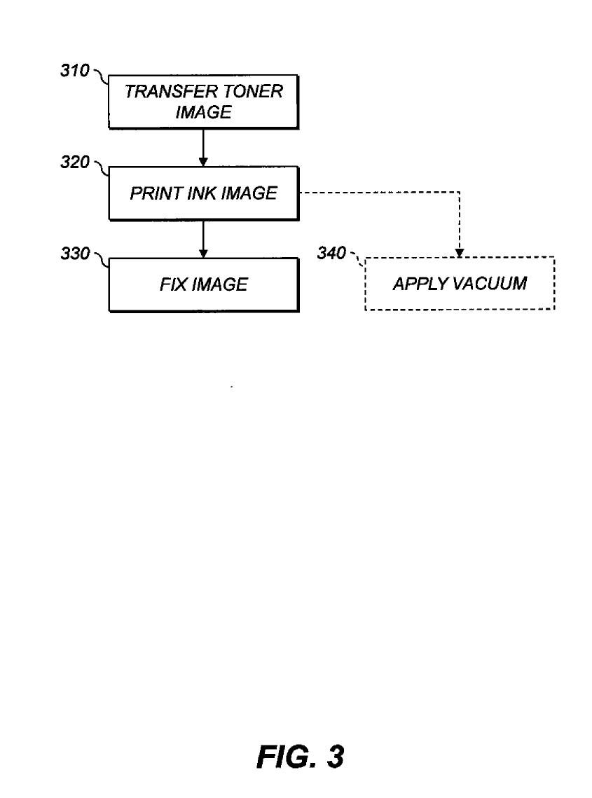

FIG. 3 shows methods of printing an image according to various embodiments. Processing begins with step 310.

In step 310, a toner image is transferred onto an image-bearing side of a receiver to form a continuous or discontinuous toner image layer having a continuous or discontinuous visible surface. That is, colorant landing on the visible surface can be seen. The toner is deposited as an image, not flood-coated. The visual and tactile features of the receiver being printed on are therefore not altered in the unprinted regions. In addition to maintaining the desired surface characteristics of the paper, this reduces the amount of material that must be removed during deinking. In various embodiments, the toner is clear or has an open-cell structure to permit absorbing ink or colorant in the ink. In various embodiments, the toner is hydrophilic. Step 310 is followed by step 320.

In step 320, an ink image is printed onto the toner visible image, the ink including colorant suspended or dissolved in a hydrophilic solvent or carrier fluid. At least 50% of the colorant is absorbed into, or adsorbed onto, toner. Step 320 is followed by step 330 and optionally by step 340.

In step 330, the toner visible image and the ink image are fixed to the receiver, e.g., by fuser 60 (FIG. 1). Colorants or functional components not absorbed into the toner in step 320 can be absorbed by the toner when the toner becomes viscous (temperature above T_{g}) during fixing. Colorants or functional components can also be incorporated into the viscous toner by pressure applied during the fixing step.

In optional step 340, vacuum is applied to a non-image-bearing side of the receiver (e.g., non-image-bearing surface 244, FIG. 2) after printing the ink image to extract the absorbed carrier fluid therefrom. The vacuum nozzle can be in contact with the receiver or not. Vacuuming can be performed before, during, or after fixing (step 330).

In various embodiments, heat, hot air, or other drying methods are applied to the image-bearing side or the non-image-bearing side of the receiver after printing the ink image to remove absorbed carrier fluid therefrom. Fluid removal can be performed in contact with the receiver or not, and can be performed before, during, or after fixing.

In various embodiments, the toner is soluble in a nonpolar organic solvent. Examples of such solvents include various alkane and aromatic compounds such as pentane, hexane, heptane, octane, benzene, toluene, xylene, dichloromethane, and trichloromethane.

In various embodiments, the toner includes a thermoplastic binder such as polyester or polystyrene. These materials are amorphous and soften at temperatures above their glass transition temperature. In various embodiments, these materials are not semicrystalline and the thermoplastic binder is not cross-linked (over time, or upon exposure to heat or UV light) or thermoset.

In various embodiments, at least one cell in the open-cell porous structure of the toner contains hydrophilic addenda.

In various embodiments, the toner is hydrophobic. Colorant in the ink is therefore trapped by the toner, and the hydrophilic solvent used in the ink passes through the toner and is absorbed by the image bearing paper or receiver. Hydrophobic toner can have an open cell porous structure to capture colorant more effectively.

In various embodiments, at least some of the carrier fluid is absorbed by the receiver.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a voltage source
22 exposure subsystem
23 toning station
23a voltage source
25 photoreceptor
25a voltage source
31, 32 electrophotographic (EP) marking engine
38 toner image
39 fused image
40 supply unit
42, 42A, 42B, 42C receiver
50 transfer subsystem
60 fuser
62 fusing roller
64 pressure roller
66 fusing nip
68 release fluid application substation
70 inkjet marking engine
71 ink manifold
72 heater
76 nozzle
77 ink drop
78 ink image
90 finisher
91 output tray
95 transport web
96 cleaning station
99 logic and control unit (LCU)
100 printer
220h, 220n carrier fluid molecule
238a, 238b, 238c toner particle
242 image-bearing surface
244 non-image-bearing surface
255 colorant
258 pore
286 functional component
310 transfer toner image step
320 print ink image step
330 fix image step
340 apply vacuum step

1. A printed article, comprising:
a) a receiver having an image-bearing surface, the image-bearing surface having substantially no human-visible colorant thereon;
b) a pattern of toner deposited on the image-bearing surface and covering less than 100% of the image-bearing surface; and
c) colorant absorbed into or adsorbed onto the toner to provide a human-visible image.

2. The printed article according to claim 1, wherein the colorant includes a dye.

3. The printed article according to claim 1, wherein the toner includes a thermoplastic binder.

4. The printed article according to claim 3, where the thermoplastic binder is not capable of being cross-linked or becoming a thermoset.

5. The printed article according to claim 1, wherein the toner is hydrophilic.

6. The printed article according to claim 1, wherein the toner has an open-cell porous structure.

7. The printed article according to claim 6, wherein at least one cell in the open-cell porous structure of the toner contains hydrophilic addenda.

8. The printed article according to claim 1, wherein the toner is hydrophobic.

9. The printed article according to claim 8, wherein the toner has an open-cell porous structure.

10. The printed article according to claim 1, wherein the colorant includes a pigment.

11. The printed article according to claim 1, further including a functional component absorbed or incorporated into the toner, the functional component selected from the group consisting of a colorant, a humectant, a surfactant, a security material, a fungicide, and a biocide.
